(19) United States
(12) Patent Application Publication
(10) Pub. No.: US 2009/0283992 A1
(43) Pub. Date: Nov. 19, 2009

(54) Curtain airbag device

(75) Inventors: Sakae Sugimori, Tokyo (JP); Kenji Nakamura, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 12/320,109

(22) Filed: Jan. 16, 2009

(30) Foreign Application Priority Data
May 14, 2008 (JP) 2008-126569

(51) Int. Cl. B60R 21/21

(52) U.S. Cl. 280/730.2

(57) ABSTRACT

A curtain airbag that can be inflated with gas from an inflator and deployed along a side surface of a vehicle cabin. The curtain airbag includes, in an occupant restraint area corresponding to an occupant's position, a multistage chamber section comprising an upper chamber that is arranged at an upper side; a lower chamber that is arranged below the upper chamber; and a discharge passage that is arranged at a middle portion in a vertical direction between the upper chamber and the lower chamber. The discharge passage communicates with at least one of said upper chamber and said lower chamber to discharge gas from said upper chamber and/or said lower chamber through the discharge passage and is adapted to reduce its cross section when pressed by the occupant's head.

### BACKGROUND

The present application relates to a curtain airbag, which is inflated along a side surface of a vehicle cabin in the event of an emergency such as a vehicle collision to protect an occupant, and a curtain airbag device having the same.

An airbag device for protecting an occupant is known in which an inflator is actuated in the event of an emergency such as a vehicle collision, a rollover, or the like and an airbag body is inflated with gas spouted out from the inflator.

An example of a curtain-type airbag device in which its air bag body is inflated and deployed along each of side surfaces (left and right surfaces in which respective pillars and side glasses are arranged, respectively) of the vehicle cabin so as to protect the side of the occupant is disclosed Japanese Patent Application No. JP-A-2007-76534 (incorporated by reference herein).

The airbag body of the curtain-type airbag device has a front air chamber for protecting mainly a front seat occupant as one of air chambers and is provided with a tether belt extending within the front air chamber in the anteroposterior direction of the vehicle between an outside fabric and an inside fabric. The tether belt divides the front air chamber into an upper divided chamber and a lower divided chamber. The upper divided chamber and the lower divided chamber are allowed to communicate with each other via a gas vent hole formed in the tether belt. Therefore, when supplied with gas spouted from the inflator, the front air chamber can be entirely inflated and deployed as a single chamber and has a dual chamber structure that the inside thereof is divided into the upper divided chamber and the lower divided chamber of which lengths in the vertical direction are substantially equal.

The airbag body is also provided with a sub inflation air chamber below the lower divided chamber. Spouted gas is introduced into the sub inflation chamber from the lower divided chamber through a vent hole and is accumulated in the sub inflation air chamber. With this structure mentioned above, spouted gas supplied from the inflator flows into the upper divided chamber of the front air chamber, the lower divided chamber of the front air chamber, and the sub inflation air chamber in this order so that the air bag body is inflated and deployed downwards.

In the aforementioned curtain-type airbag device, spouted gas flows into the respective chambers of the airbag body in the aforementioned order to inflate and deploy the respective chambers. However, there must be a time lag between when the upper divided chamber positioned the upper side reaches a sufficiently inflated state and when the sub inflation air chamber obtains its sufficiently inflated state.

It is an object of at least one disclosed embodiment to provide a curtain airbag and a curtain airbag device capable of promptly ensuring sufficient restraining performance over a wide occupant restraint area.

### SUMMARY

One disclosed embodiment relates to a curtain airbag that can be inflated with gas from an inflator and deployed along a side surface of a vehicle cabin. The curtain airbag includes, in an occupant restraint area corresponding to an occupant's position, a multistage chamber section comprising an upper chamber that is arranged at an upper side; a lower chamber that is arranged below the upper chamber; and a discharge passage that is arranged at a middle portion in a vertical direction between the upper chamber and the lower chamber. The discharge passage communicates with at least one of said upper chamber and said lower chamber to discharge gas from said upper chamber and/or said lower chamber through the discharge passage and is adapted to reduce its cross section when pressed by the occupant's head.

Another embodiment relates to a curtain airbag device comprising a curtain airbag that can be inflated with gas from an inflator and deployed along a side surface of a vehicle cabin; and an inflator for supplying said gas for inflating and deploying said curtain airbag. The curtain airbag includes, in an occupant restraint area corresponding to an occupant's position, a multistage chamber section comprising an upper chamber that is arranged at an upper side; a lower chamber that is arranged below the upper chamber; and a discharge passage that is arranged at a middle portion in a vertical direction between the upper chamber and the lower chamber. The discharge chamber communicates with at least one of said upper chamber and said lower chamber to discharge gas from said upper chamber and/or said lower chamber through the discharge passage and is adapted to reduce its cross section when pressed by the occupant's head.

It is to be understood that both the forgoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is an explanatory illustration showing a state that an embodiment of a curtain airbag device that is mounted to an automobile and is inflated and deployed.

FIG. 2(a) is a plan view of the curtain airbag body.

FIG. 2(b) is a sectional view taken along a line IIb-IIb in FIG. 2(a) of the curtain airbag body in the inflated state.

FIG. 3(a) is a sectional view showing a restraining state in which the occupant's head collides with the upper large-diameter chamber.

FIG. 3(b) is a sectional view showing a restraining state in which the occupant's head collides with the lower large-diameter chamber.

FIG. 4(a) is a sectional view showing an initial restraining state in which the occupant's head collides with a portion between the upper large-diameter chamber and the lower large-diameter chamber.

FIG. 4(b) is a sectional view showing a restraining state following the restraining state shown in FIG. 4(a).

FIG. 5 is a plan view of a curtain airbag body of another embodiment in which another multistage chamber section corresponding to a row of rear seats is provided.

### DETAILED DESCRIPTION

According to an exemplary embodiment, an airbag device for protecting an occupant includes an inflator that is actuated in the event of an emergency such as a vehicle collision, a rollover, or the like and an airbag body is inflated with gas spouted out from the inflator.

According to one exemplary embodiment, a curtain airbag is provided that can be inflated with gas from an inflator and deployed along a side surface of a vehicle cabin. The curtain airbag includes, in an occupant restraint area corresponding to an occupant's position, a multistage chamber section comprising: an upper chamber that is arranged at an upper side; a lower chamber that is arranged below the upper chamber; and a discharge passage that is arranged at a middle portion in a vertical direction between the upper chamber and the lower chamber. The discharge chamber communicates with at least one of said upper chamber and said lower chamber to discharge gas from said upper chamber and/or said lower chamber through the discharge passage and is adapted to reduce its cross section when pressed by the occupant's head.

The occupant's head can be restrained in aspect corresponding to the position in height of the head even though there are significant differences in height of the head according to the posture and/or body size of the occupant. That is, when the head is in relatively upper position and thus collides only with the upper chamber or when the head is in relatively lower position and thus collides only with the lower chamber, the head can be received at a suitable contact point which is located at substantially the center in the vertical direction of the chamber. When the occupant's head contacts the upper chamber or the lower chamber, a part of gas flows out from the inside of the chamber through the discharge passage so as to absorb excess bounce, thereby providing good restraining performance. When the occupant's head is in middle position in height and thus collides with the portion between the upper chamber and the lower chamber, the head can be received by the two upper and lower chambers simultaneously and the head narrows the cross section of the discharge passage to prevent pressure gas from flowing out of the inside of both the two upper and lower chambers. Therefore, the head is received evenly by the two upper and lower chambers with inner pressures in the chambers maintained. Maintaining the pressures in the upper chamber and lower chamber with the head contacting both chambers provides good restraining performance. As a result of this, a wide area along the vertical direction of the vehicle can be obtained as the occupant restraint area in the curtain airbag.

Gas from the inflator is supplied into the upper chamber and the lower chamber simultaneously, whereby the curtain airbag body is promptly inflated and developed over the entire shape in the vertical direction. As a result, sufficient restraining performance can be obtained in the area corresponding to the position in height of the head even though there are significant differences in height of the head according to the posture and/or body size of the occupant. That is, sufficient restraining performance can be ensured promptly over the wide occupant restraint area.

According to one exemplary embodiment, the cross section of said discharge passage is smaller than the cross section of each of said upper chamber and said lower chamber. Accordingly, when the occupant's head collides with the portion between the upper chamber and the lower chamber, the head is received by the two upper and lower chamber and the discharge passage therebetween simultaneously and is therefore supported at closely-spaced three points, thereby dispersing the collision load with a wide receiving area and thus providing good restraining performance.

According to one exemplary embodiment, the curtain airbag further includes a discharge chamber formed on one side of said multistage chamber section in the anteroposterior direction of the vehicle, wherein said discharge passage communicates with both of said upper chamber and said lower chamber to discharge gas from said upper chamber and said lower chamber into said discharge chamber. Accordingly, it is possible to maintain the inflation retention capability as a whole of the curtain airbag without losing the pressure gas.

According to another exemplary embodiment, the discharge passage communicates with both of said upper chamber and said lower chamber to discharge gas from said upper chamber and said lower chamber to the outside of the curtain airbag. Accordingly, it is possible to smoothly discharge the gas from the upper chamber and the lower chamber.

According to an exemplary embodiment, said upper chamber, said discharge passage, and said lower chamber are formed into tubular shapes which are parallel to the anteroposterior direction of the vehicle within said occupant restraint area. Accordingly, the multistage chamber section can provide restraining performance which is substantially constant along the anteroposterior direction of the vehicle.

According to an exemplary embodiment, said discharge passage is partitioned from said upper chamber and said lower chamber by sewing lines and is formed by the sewing lines. Accordingly, the discharge passage is closely adjacent to the two chambers. Therefore, when the occupant's head collides with the portion between the upper chamber and the lower chamber, the head is supported at closely-spaced locations of the two chambers and the discharge passage therebetween, thereby stably restraining the head. In addition, the discharge passage can be formed simply by sewing process, thereby reducing the manufacturing cost.

According to an exemplary embodiment, a plurality of said multistage chamber sections are arranged at positions corresponding to a plurality of rows of seats in a vehicle cabin. Accordingly, the heads of occupants sitting in the respective rows of seats can be restrained by the multistage chambers, respectively.

Forming a curtain airbag with one or more multistage chambers including an upper chamber, a lower chamber, and a discharge chamber facilitates ensuring sufficient restraining performance with a wide occupant restraint area.

Hereinafter, an embodiment will be described with reference to attached drawings.

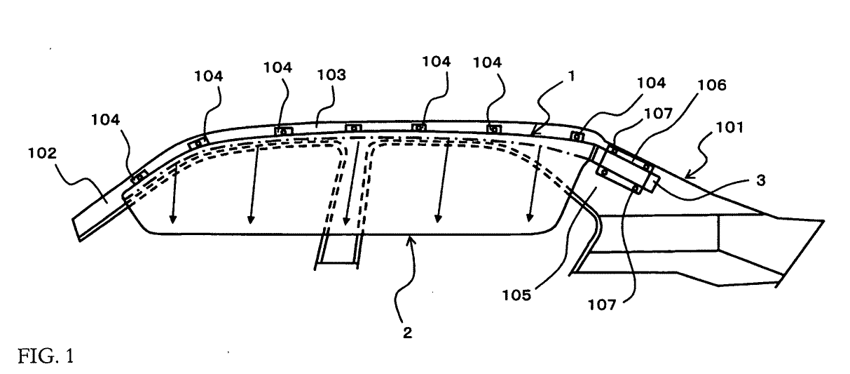

FIG. 1 is an explanatory illustration showing a state that a curtain airbag device according to the an exemplary embodiment is mounted to an automobile and is inflated and deployed. In the following description, the left side in this drawing represents the front side of the vehicle 101 and the right side in this drawing is the rear side of the vehicle 101.

In FIG. 1, the curtain airbag device 1 has a generally curved arcuate shape in the longitudinal direction that corresponds generally with an arcuate roof side rail 103. The curtain airbag device 1 is coupled to the roof side rail 103 along a corner between a ceiling and a side surface of a vehicle cabin of the vehicle 101 (shown by a dashed-dotted line in FIG. 1) from an A-pillar 102 (front pillar) by brackets 104.

The curtain airbag device 1 comprises a curtain airbag body (curtain airbag) 2 which can be inflated and deployed downwards along the side surface of the vehicle cabin, as shown, from the folded state at the aforementioned corner. The curtain airbag device 1 further includes an inflator 3 which supplies pressure gas into the curtain airbag body 2 from a rear end side of the curtain airbag body 2, and an inflator control circuit (not shown) which detects a collision and sends an ignition signal to the inflator 3. The inflator 3 is attached to a C-pillar 105 (rear pillar) in a rear portion of the vehicle 101 via a bracket 106 by bolts 107.

In the event of a lateral collision or a rollover of the vehicle 101, the sensor of the inflator control circuit detects the lateral collision or the rollover and outputs an actuation signal to an initiator (not shown) of the inflator 3. Accordingly, the inflator 3 is actuated to supply a pressure gas for inflating the airbag so that the pressure gas flows into the curtain airbag body 2, thereby inflating and deploying the curtain airbag body 2 downwards as shown in FIG. 1. In the inflated state, the curtain airbag body 2 is configured to receive the occupant's head from the side to absorb the load, thereby restraining the occupant.

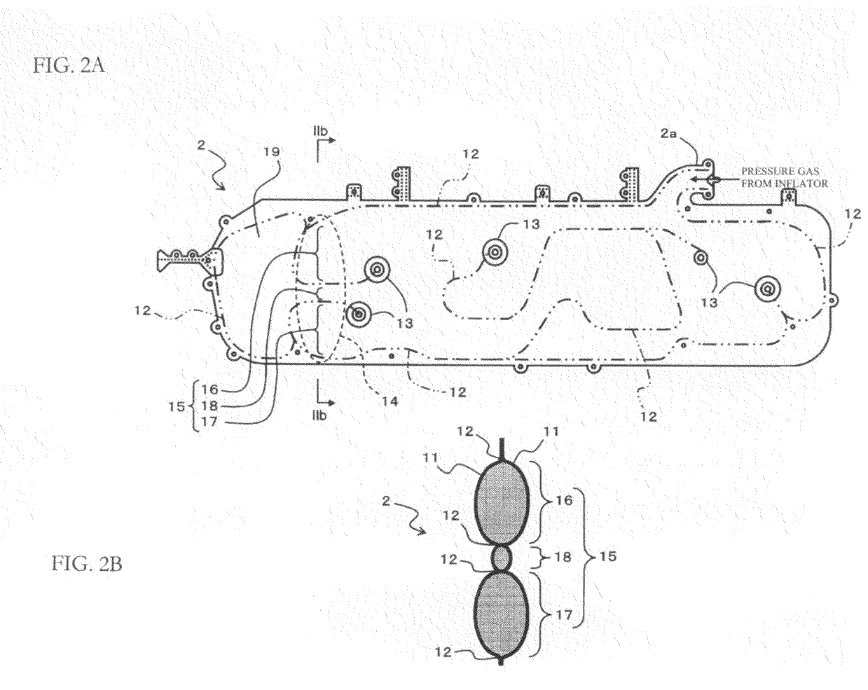

FIG. 2(a) is a plan view of the curtain airbag body 2 and FIG. 2(b) is a sectional view taken along a line IIb-IIb in FIG. 2(a) of the curtain airbag body in the inflated state. As shown in FIG. 2(a), 2(b), the curtain airbag body 2 is formed by superposing two base fabric panels 11 having substantially the same shape (e.g., generally rectangular). The fabric panels 11 are coupled together by sewing along a portion near the edge of the entire body and along sewing lines 12 at suitable inner positions. In the uninflated state, the curtain airbag body 2 is folded and stored along the corner, as shown in FIG. 1 by a dashed-dotted line. In the event of an emergency, pressure gas spouted out from the inflator 3 flows into the curtain airbag body 2 through a pressure gas inlet 2a formed at an upper right end portion in FIG. 2(a) (e.g., at an upper rear end side when the curtain airbag device is mounted to the vehicle 101). The curtain airbag body 2 is entirely inflated and deployed so that respective sealed areas surrounded by the sewing lines 12 become to have increased thicknesses. In this state, portions sewn by the sewing lines 12 are non-inflatable areas where the two fabrics 11 are closely attached. Connected points 13 are formed at ends of each sewing line 12 to prevent the portion sewn by the sewing line 12 from unraveling.

The curtain airbag body 2 of this embodiment has a multistage chamber section 15 in an occupant restraint area 14 (area surrounded by a broken line in FIG. 2(a)) for restraining the occupant's head corresponding to the position of the occupant sitting in a front seat. The occupant restraint area 14 is an area where the occupant wearing a seat belt and sitting in the normal state in the front seat is received at his/her head by the curtain airbag body 2 in the event of an emergency. The occupant restraint area 14 has a long length in the vertical direction of the vehicle to effectively restrain occupants of differences in the heights, sitting postures or body size.

The multistage chamber section 15 in the occupant restraint area 14 of the curtain airbag body 2 comprises an upper large-diameter chamber (upper chamber) 16 that is arranged at an upper side and has a relatively large cross section when inflated, a lower large-diameter chamber (lower chamber) 17 that is arranged below the upper large-diameter chamber 16 and has a relatively large cross section when inflated, and a discharge passage 18 that is arranged adjacent to and between the upper large-diameter chamber 16 and the lower large-diameter chamber 17 and has a relatively small cross section.

The upper large-diameter chamber 16, the discharge passage 18, and the lower large-diameter chamber 17 are formed into tubular shapes which are parallel to the anteroposterior (e.g., front to back) direction of the vehicle within the occupant restraint area 14. The discharge passage 18 is partitioned from the upper large-diameter chamber 16 and the lower large-diameter chamber 17 by the sewing lines 12. The rear side (the right side in FIG. 2(a)) of the discharge passage 18 communicates with both the inside of the upper large-diameter chamber 16 and the inside of the lower large-diameter chamber 17. The opposite side (the left side in FIG. 2(a)) of the discharge passage, i.e. the front side of the discharge passage 18, communicates with a discharge chamber 19.

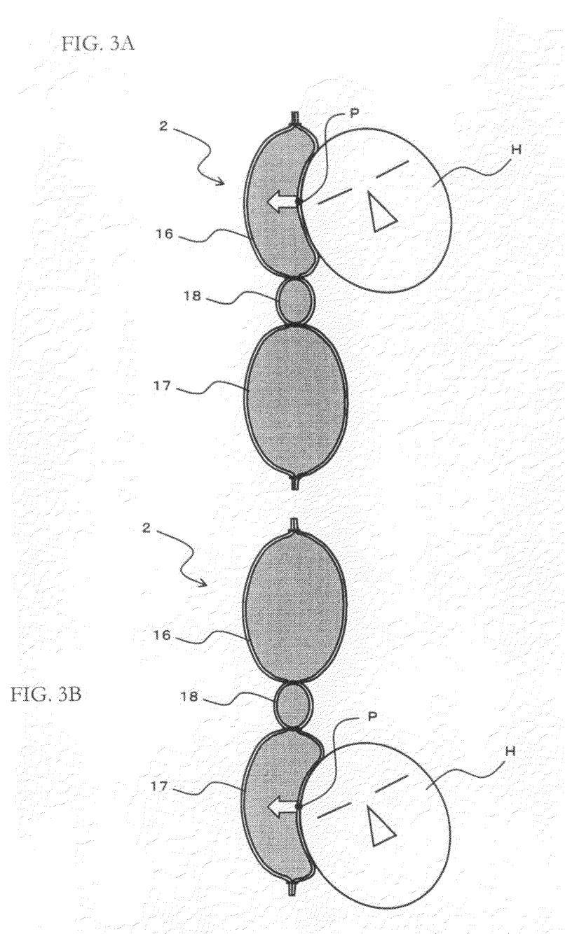

FIG. 3(a) is a sectional view showing a restraining state in which the occupant's head collides with the upper large-diameter chamber 16. When the occupant's head H is in relatively high position (e.g., because of a tall height, because of a tall sitting height, because of a proper sitting position) the occupant's head H is received only by the upper large-diameter chamber 16 which is positioned at a relatively upper side of the occupant restraint area 14 of the curtain airbag body 2 as shown in FIG. 3(a). In this case, the head H can be received at a center receiving point P which is positioned at the center in the vertical direction of the upper large-diameter chamber 16 and is capable of receiving enough large load, thereby providing good restraining performance. In this case, a part of pressure gas in the upper large-diameter chamber 16 flows into the discharge chamber 19 through the discharge passage 18 (the discharge passage 18 functions as a gas-release passage; see FIG. 2(a)), thereby suitably absorbing the bounce of the upper large-diameter chamber 16 and thus restraining the head H well.

FIG. 3(b) is a sectional view showing a restraining state in which the occupant's head collides with the lower large-diameter chamber 17. When the occupant's head H is in relatively low position (e.g., because of a short height, because of a short sitting height, because the occupant sits on the edge of the seat), the occupant's head H is received only by the lower large-diameter chamber 17 which is positioned at a relatively lower side of the occupant restraint area 14 of the curtain airbag body 2 as shown in FIG. 3(b). Also in this case, the head H can be received in an aspect similarly to the case of being received only by the upper large-diameter chamber 16 as mentioned above, thereby providing good restraining performance.

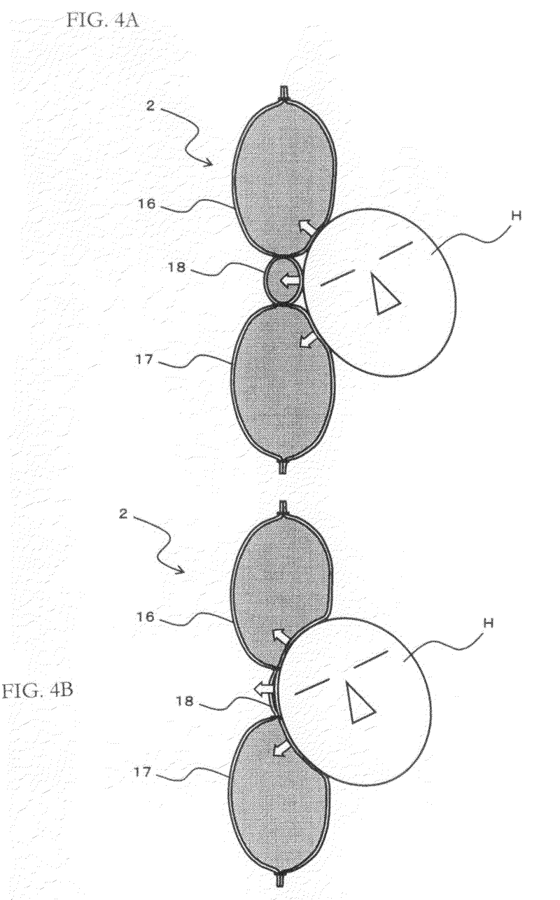

FIG. 4(a) is a sectional view showing a restraining state in which the occupant's head collides with a portion between the upper large-diameter chamber 16 and the lower large-diameter chamber 17. When the occupant's head H is in an intermediate position in height, the head H is out of both the center receiving point P of the upper large-diameter chamber 16 and the center receiving point P of the lower large-diameter chamber 17. Instead, the head H collides with the upper large-diameter chamber 16, the lower large-diameter chamber 17, and the discharge passage 18 therebetween simultaneously and is therefore supported at closely-spaced three points. Contacting all three chambers 16, 17, and 18 disperses the collision load with a wide receiving area and thus providing good restraining performance. In this embodiment, the cross section of the discharge passage 18 is set to be smaller than the cross section of the upper large-diameter chamber 16 and the cross section of the lower large-diameter chamber 17.

When the collision of the head H advances, as shown in FIG. 4(b), the head H narrows the flowing section of the discharge passage 18, preventing the pressure gas from flowing out of the inside of the two large-diameter chambers 16 and 17. When the head H collides with the two large-diameter chambers 16, 17 simultaneously, the upper large-diameter chamber 16 and the lower large-diameter chamber 17 are not required to decrease the bounce thereof as compared to the case that the head H collides only with the upper large-diameter chamber 16 or the lower large-diameter chamber 17 (as shown in FIG. 3(a) or FIG. 3(b). Since the discharge passage 18 is narrowed to prevent the pressure gas from flowing out as mentioned above, the head H collides with the two large-diameter chambers 16, 17 with the inner pressures maintained, thereby providing good restraining performance.

In the curtain airbag device 1 of this embodiment, the head H can be restrained in aspect corresponding to the position in height of the head H even though there are differences in height of the head H according to the posture and/or body size of the occupant. That is, when the head H is in relatively upper position and thus collides only with the upper large-diameter chamber 16 or when the head H is in relatively lower position and thus collides only with the lower large-diameter chamber 17, the head H can be received at the suitable contact point P which is located at substantially the center in the vertical direction of the chamber 16 or 17 and, further, a part of pressure gas flows out from the inside of the chamber 16 or 17 through the discharge passage 18 so as to absorb excess bounce, thereby providing good restraining performance.

When the occupant's head H is in middle position in height and thus collides with the portion between the upper large-diameter chamber 16 and the lower large-diameter chamber 17, the head H can be received by the two upper and lower chambers 16 and 17 simultaneously and the head H narrows the flowing section of the discharge passage 18 to prevent pressure gas from flowing out of the inside of both the two upper and lower chambers 16 and 17. Therefore, the head H is received by the two upper and lower chambers 16 and 17 with inner pressures thereof maintained, thereby, also in this case, providing good restraining performance.

As a result of this, the occupant restraint area 14 of the curtain airbag body 2 of this embodiment is set to be a wide range continuing in the vertical direction of the vehicle which is effective for restraining the occupant's head so as to obtain a wide occupant restraining area of the curtain airbag device 1 as compared to a curtain airbag body having such an arrangement of restraining the head H only by a single large-diameter chamber having simply one central contact point P (or by a plurality of chambers having substantially the same volume which are aligned).

In any of the aforementioned cases, pressure gas from the inflator is supplied into the upper large-diameter chamber 16 and the lower large-diameter chamber 17 simultaneously. The curtain airbag body 2 is thereby promptly inflated and developed over the entire shape in the vertical direction. As a result, sufficient restraining performance can be obtained in the area corresponding to the position in height of the head H even though there are significant differences in height of the head H according to the posture and/or body size of the occupant. That is, sufficient restraining performance can be ensured promptly over the wide occupant restraint area 14.

Also in this embodiment, pressure gas is discharged into the discharge chamber 19 from the upper large-diameter chamber 16 or the lower large-diameter chamber 17 via the discharge passage 18, thereby maintaining the inflation retention capability as a whole of the curtain airbag body 2 without losing the pressure gas.

The front side of the discharge passage 18 may have a function as a vent hole opening toward the outside air not for communicating with the closed discharge chamber 19. In this case, it is possible to smoothly discharge the pressure gas from the upper large-diameter chamber 16 and the lower large-diameter chamber 17.

In this embodiment, the upper large-diameter chamber 16, the discharge passage 18, and the lower large-diameter chamber 17 are formed into tubular shapes which are substantially parallel to the anteroposterior direction of the vehicle within the occupant restraining area 14, whereby the multistage chamber section 15 can provide restraining performance which is substantially constant along the anteroposterior direction of the vehicle.

Also in this embodiment, the discharge passage 18 is partitioned from the upper large-diameter chamber 16 and the lower large-diameter chamber 17 by the sewing lines 12 and is thus formed so that the discharge passage 18 is closely adjacent to the two large-diameter chambers 16, 17. Therefore, when the occupant's head H collides with the portion between the upper large-diameter chamber 16 and the lower large-diameter chamber 17, the head H is supported at closely-spaced points of the two large-diameter chambers 16, 17 and the discharge passage 18 therebetween, thereby stably restraining the head H. In addition, the discharge passage 18 can be formed simply by sewing process, thereby reducing the manufacturing cost.

Though the curtain airbag body described above includes only a multistage chamber section at a portion corresponding to the front seat, according to another exemplary embodiment, a multistage chamber section corresponding to a rear seat may be provided instead of or in addition to a portion corresponding to the front seat.

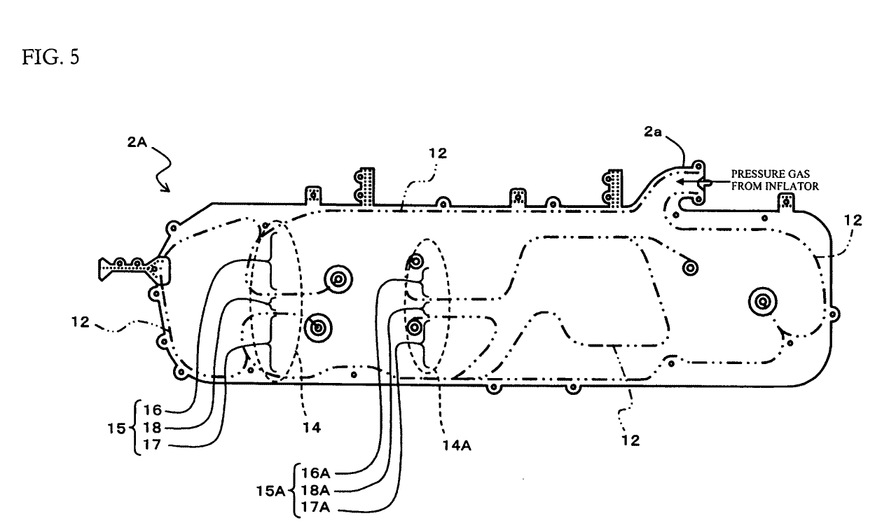

FIG. 5 is a plan view of a curtain airbag body 2A of a curtain airbag device of the another embodiment. A rear occupant restraint area 14A where the head H of an occupant sitting in the rear seat may collides is further formed on a rear side (the right side in FIG. 5) of the occupant restraint area 14 corresponding to the front seat. A rear multistage chamber section 15A is provided in the rear occupant restraint area 14A. The rear multistage chamber section 15A comprises an upper large-diameter chamber 16A, a lower large-diameter chamber 17A, and a discharge passage 18A. The chambers 16A and 17A and the passage 18A are partitioned by sewing lines 12 and are thus formed so that the front side (the left side in FIG. 5) of the discharge passage 18A communicates with both the upper large-diameter chamber 16A and the lower large-diameter chamber 17A.

With the rear multistage chamber section 1 SA having the aforementioned structure, prompt restraining performance similar to the multistage chamber section 15 can be obtained and the rear occupant restraint area 14A is set to be a wide area along the vertical direction of the vehicle.

A plurality of multistage chamber sections 15, 15A are provided at positions corresponding to a plurality of rows of seats in the vehicle cabin, respectively, whereby the heads H of occupants sitting in the respective seats can be restrained by the multistage chamber sections 15, 15A, respectively. In case of a vehicle having three rows of seats or more, multistage chamber sections 15 may be provided at positions corresponding to the arrangements of the rows of seats, respectively.

Though the aforementioned embodiments are examples of preferred modes of the present invention, the present invention is not limited thereto and various changes and modifications could be made without departing from the scope and the technical spirit of the present invention.

The priority application, Japanese Patent Application No. 2008-126569, filed May 14, 2008 including the specification, drawings, claims and abstract, is incorporated herein by reference in its entirety.

What is claimed is:

1. A curtain airbag that can be inflated with gas from an inflator and deployed along a side surface of a vehicle cabin, wherein
said curtain airbag includes, in an occupant restraint area corresponding to an occupant's position, a multistage chamber section comprising:
an upper chamber that is arranged at an upper side;
a lower chamber that is arranged below the upper chamber; and
a discharge passage that is arranged at a middle portion in a vertical direction between the upper chamber and the lower chamber and that communicates with at least one of said upper chamber and said lower chamber to discharge gas from said upper chamber and/or said lower chamber through the discharge passage and wherein the cross section of the discharge passage is adapted to be reduced in cross section when pressed by the occupant's head.

2. A curtain airbag as claimed in claim 1, wherein the cross section of said discharge passage is smaller than the cross section of each of said upper chamber and said lower chamber.

3. A curtain airbag as claimed in claim 2, further comprising a discharge chamber formed on one side of said multistage chamber section in the anteroposterior direction of the vehicle, wherein said discharge passage communicates with both of said upper chamber and said lower chamber to discharge gas from said upper chamber and said lower chamber into said discharge chamber.

4. A curtain airbag as claimed in claim 2, wherein said discharge passage communicates with both of said upper chamber and said lower chamber to discharge gas from said upper chamber and said lower chamber to the outside of the curtain airbag.

5. A curtain airbag as claimed in claim 4, wherein said upper chamber, said discharge passage, and said lower chamber are formed into tubular shapes which are parallel to the anteroposterior direction of the vehicle within said occupant restraint area.

6. A curtain airbag as claimed in claim 5, wherein said discharge passage is partitioned from said upper chamber and said lower chamber by sewing lines and is thus formed.

7. A curtain airbag as claimed in claim 6, wherein a plurality of said multistage chamber sections are arranged at positions corresponding to a plurality of rows of seats in a vehicle cabin.

8. A curtain airbag device comprising:
a curtain airbag that can be inflated with gas from an inflator and deployed along a side surface of a vehicle cabin; and
an inflator for supplying said gas for inflating and deploying said curtain airbag, wherein
said curtain airbag includes, in an occupant restraint area corresponding to an occupant's position, a multistage chamber section comprising:
an upper chamber that is arranged at an upper side; a lower chamber that is arranged below the upper chamber; and a discharge passage that is arranged at a middle portion in a vertical direction between the upper chamber and the lower chamber and that communicates with at least one of said upper chamber and said lower chamber to discharge gas from said upper chamber and/or said lower chamber through the discharge passage and wherein the cross section of the discharge passage is adapted to be reduced in cross section when pressed by the occupant's head.
